(19) United States
(12) Patent Application Publication
(10) Pub. No.: US 2015/0041455 A1
(43) Pub. Date: Feb. 12, 2015

(54) HEATING ELEMENT

(71) Applicant: Behr-Hella Thermocontrol GmbH, Lippstadt (DE)

(72) Inventors: Harri PANKRATZ, Soest (DE); Hans-Joachim THIEMANN, Bueren (DE)

(21) Appl. No.: 14/524,667

(22) Filed: Oct. 27, 2014

Related U.S. Application Data
(63) Continuation of application No. PCT/EP2013/058665, filed on Apr. 25, 2013.

(30) Foreign Application Priority Data
Apr. 26, 2012 (DE) 10 2012 206 991.7

(51) Int. Cl. H05B 6/10

(52) U.S. Cl. CPC H05B 6/105
USPC 219/634

(57) ABSTRACT

A heating element, in particular a heating element for inductive heating, having an electrically conductive material which can be introduced into a magnetic field, produced by alternating current, of an induction coil, characterized in that the electrically conductive material is divided into a plurality of individual material sections, which are spaced apart from one another in electrically nonconductive fashion and are connected to form a closed conductor network by electrically conductive connecting elements.

This nonprovisional application is a continuation of International Application No. PCT/EP2013/058665, which was filed on Apr. 25, 2013, and which claims priority to German Patent Application No. DE 10 2012 206 991.7, which was filed in Germany on Apr. 26, 2012, and which are both herein incorporated by reference.

### BACKGROUND OF THE INVENTION

1. Field of the Invention

The present invention relates to a heating element, in particular to a heating element for induction heating, comprising an electrically conductive material, which can be introduced into a magnetic field, generated by an alternating current, of an induction coil.

2. Description of the Background Art

Electrically conductive materials can be heated by induction. This occurs by placing an electrically conductive material in a magnetic field generated by an induction coil. The magnetic field is hereby generated by an alternating current, which results in a polarity reversal of the magnetic field at the frequency of the alternating current.

Eddy currents are induced in the electrically conductive material by the alternating magnetic field. These induced alternating currents work against the specific resistance of the material, as a result of which heat is produced.

Induction in this case can occur through nonconductive materials, which experience no heating. Only the radiation of heat from the electrically conductive material can lead to heating of the surrounding nonconductive materials.

Heating by induction can be found in many applications today. The most frequent industrial uses are, for instance, the tempering, annealing, melting, or welding of metals. But induction heating can be found in household appliances as well, for example, in induction cooktops.

Induction heating is used furthermore also for heating fluids that flow around a heating element. Induction heating is especially suitable for use in water circulation systems in electric vehicles, because electrical energy can be converted to heat with a relatively high efficiency. This is especially advantageous, because in electric vehicles no waste heat arises from the internal combustion engine and therefore cannot be utilized for heating the passenger compartment, for instance.

The eddy current profile and thereby also the heat distribution in the material to be heated depend very substantially on the form of the heat element, the material comprising the heating element, and the type of magnetic field of the induction coil. Nonoptimal selection of the parameters recited here can lead to a too great inhomogeneity in the heat distribution within the heating element.

This inhomogeneity is a detrimental factor particularly for the task of uniform heating of a heating element.

### SUMMARY OF THE INVENTION

It is therefore an object of the present invention to provide an arrangement for an electrically conductive material that is to be heated by induction and which allows the greatest possible homogeneity with respect to the heat distribution within the material.

In an embodiment, a heating element, in particular a heating element for induction heating, is provided that includes an electrically conductive material, which, generated by an alternating current can be introduced into a magnetic field of an induction coil, whereby the electrically conductive material is divided into a plurality of individual material sections spaced apart from one another in an electrically nonconductive manner and connected to form a closed conductor network by electrically conductive connecting elements.

The electrically conductive material can be applied to an electrically isolating support layer and/or if the material is positioned electrically isolated in an area filled with at least one medium to be heated. This is necessary to prevent an unintentional transmission of eddy currents arising in the heating element due to the alternating magnetic field of the induction coil to the environment. This would have a negative effect on the heat output from the induction heating.

At least one first surface of the material sections can be in contact with the medium to be heated. This is necessary to assure an advantageous heat transfer from the heating element to the medium to be heated.

It is moreover advantageous, if the medium surrounding the heating element is not or only very poorly electrically conductive. In this regard, “very poorly conductive” can mean, for example, a conductivity of 1/1000 or less of the conductivity of the electrically conductive material. This also contributes to a better isolation of the heating element and thus reduces the losses within the induction heating system due to unintentional transmission of induced eddy currents.

The individual material sections can be distributed in a substantially uniform or substantially nonuniform pattern or geometry in the magnetic field of the induction coil. This allows for the heating element to be tailored individually to a special intended use.

In a further embodiment, the material sections can be arranged in one or more planes. In this way, a medium to be heated can have greater surface contact with the material sections of the heating element, as a result of which the heat transfer is improved.

The material can be arranged or coiled into a spiral, whereby the individual windings or coils of the spiral are spaced apart from one another in an electrically nonconductive manner and the center of the spiral is connected to the outermost end of the spiral in an electrically conductive manner by a connecting element.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic arrangement of an induction heating system;

FIG. 2 shows an embodiment according to the invention of a heating element for an induction heating system;

FIG. 3 shows an embodiment according to the invention of a heating element for an induction heating system; and

FIG. 4 shows an embodiment according to the invention of a heating element for an induction heating system.

### DETAILED DESCRIPTION

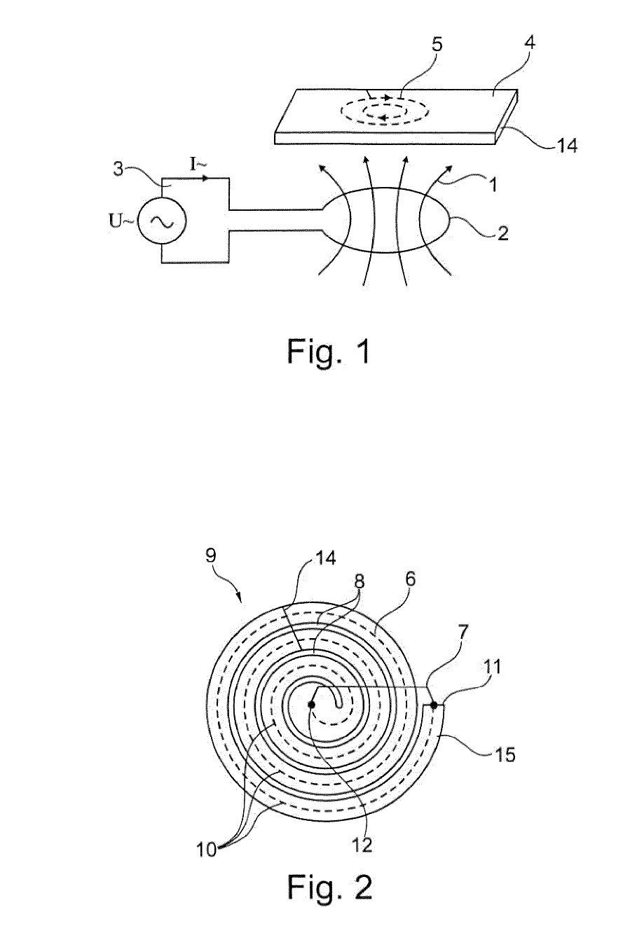

FIG. 1 shows the basic structure of an induction heating system. Shown is induction coil 2 connected to a current circuit 3, operated with an alternating voltage. A magnetic field 1 is generated in induction coil 2 by the alternating voltage in current circuit 3. Because of the alternating current applied to current circuit 3, magnetic field 1 is an alternating magnetic field, which changes its magnetic orientation with the frequency of the alternating current.

A heating element 4, comprising an electrically conductive material 14, is introduced into magnetic field 1. Eddy currents 5 are induced in heating element 4 due to magnetic field 1. Because eddy currents 5 work against the specific resistance of heating element 4, heat is produced in heating element 4.

It follows that material 14 which comprises heating element 4 must have a certain specific internal resistance to enable an effective heating of heating element 4. The internal resistance of material 14 influences the heating effect, whereby a specific optimum arises between the resistance and the heating effect.

Heating element 4 must be arranged at such a distance to induction coil 2 to be still located within the forming magnetic field. Other elements made of electrically nonconductive materials can be arranged between heating element 4 and induction coil 2.

Induction heating systems are constructed according to this simple principle. In alternative embodiments, heating element 4 can also have different external dimensions and shapes. Thus, in principle, any regular or also irregular arrangement of material 14 of heating element 4 is conceivable. Other configurations in this regard follow in the description of FIG. 2.

FIG. 2 shows a special embodiment of a heating element 4. Such a heating element 4 can be used in an arrangement already shown in FIG. 1.

Heating element 4 has an electrically conductive material 14, which is rolled up into a spiral 15. The individual tracks 10 of material 14 are electrically isolated from one another by an electrically nonconductive separating layer 8. This can occur either by a simple spacing apart, i.e., by air between tracks 10 of material 14, or by the introduction of an electrically isolating material, which then represents the electrically nonconductive separating layer 8.

Eddy currents 6 arising in heating element 4 of FIG. 2 run within tracks 10 of material 14 in the form of spiral 15. This results in a very homogeneous distribution within heating element 4. According to the homogeneous distribution of eddy currents 6 within heating element 4, heat development within heating element 4 will also be characterized by a great homogeneity.

However, to enable the formation of eddy currents 6 in the first place, the beginning 11 and end 12 of the track must have an electrically conductive connection to one another in order to form a complete electrically conductive circuit. This is realized by means of electrically conductive connection 7.

Here as well, heating element 4 can substantially be made of different materials 14, as long as the main property of electrical conductivity is fulfilled. The electrically nonconductive separating layer 8 between the individual tracks 10 can also be formed of different materials 14. The most important feature of material 14 of heating element 4 is the electrical conductivity or its internal resistance.

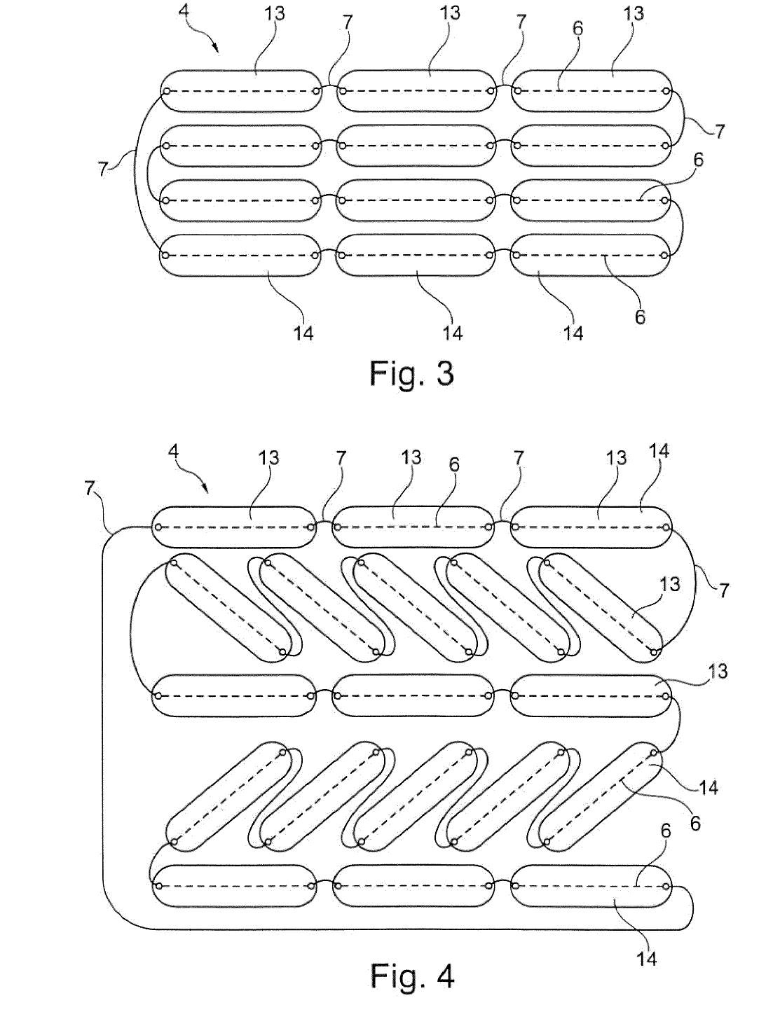

In alternative embodiments, other arrangements of the electrically conductive material are conceivable as well. In principle, any arrangement is possible, as long as the individual sections of the material are connected by electrically conductive bridges to form one or more closed electrically conductive circuits. Likewise, the individual sections can also include a combination of different materials. Examples of alternative embodiments are illustrated in FIGS. 3 and 4.

FIGS. 3 and 4 show an alternative arrangement of individual material sections 13 which together form a heating element 4. The reference characters correspond to those in FIG. 2.

It is important, as already described, that individual material sections 13 are spaced apart from one another in an electrically isolated manner, so that the eddy currents form within material sections 13 in the order predetermined by electrical connecting elements 7. All material sections 13 together must form one or more closed electrically conductive circuits.

This division of heating element 4 into a plurality of sections 13 makes it possible to form a heating element 4 which is especially designed for its intended application. Thus, defined surfaces can be heated in a targeted manner in that the arrangement of material sections 13 can be tailored to the surfaces to be heated.

Different geometries of the material sections are also conceivable in further alternative embodiments. Thus, the individual material sections can also be made as tube-like structures, so that the medium to be heated can flow not only around but also through the material sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heating element for induction heating, the heating element comprising:
an electrically conductive material that is introduced into a magnetic field of an induction coil, the magnetic field being generated by an alternating current, the electrically conductive material being divided into a plurality of individual material sections that are spaced apart from one another in an electrically nonconductive manner and are connected to form a complete conductor network by electrically conductive connecting elements.

2. The heating element according to claim 1, wherein the electrically conductive material is applied to an electrically isolating support layer.

3. The heating element according to claim 1, wherein the electrically conductive material is positioned electrically isolated in an area filled with at least one medium to be heated.

4. The heating element according to claim 3, wherein at least one first surface of the material sections is in contact with the medium to be heated.

5. The heating element according to claim 3, wherein the medium surrounding the heating element is not or only very slightly electrically conductive.

6. The heating element according to claim 1, wherein the individual material sections are distributed in a substantially uniform or substantially nonuniform pattern in the magnetic field of the induction coil.

7. The heating element according to claim 1, wherein the material sections are arranged in one or more planes.

8. The heating element according to claim 1, wherein the material is arranged or coiled into a spiral, wherein the individual windings or coils of the spiral are spaced apart from one another in an electrically nonconductive manner, and wherein the center of the spiral is connected to the outermost end of the spiral in an electrically conductive manner by a connecting element.

9. An arrangement of a heating element according to claim 1, wherein the heating element is positioned electrically isolated in a spatially limited area and is there brought into contact with a fluid to be heated, the heating element being furthermore arranged in a magnetic field of an induction coil, which is integrated in a current circuit operable with alternating current.
